(19) United States
(12) Patent Application Publication
(10) Pub. No.: US 2015/0242998 A1
(43) Pub. Date: Aug. 27, 2015

(54) DISPLAY SYSTEM, HEALTH APPARATUS, AND DISPLAY CONTROL METHOD

(71) Applicant: Seiko Epson Corporation, Tokyo (JP)

(72) Inventors: Takayuki KITAZAWA, Suwa (JP); Hideki TANAKA, Chino (JP)

(21) Appl. No.: 14/623,191

(22) Filed: Feb. 16, 2015

(30) Foreign Application Priority Data
Feb. 26, 2014 (JP) 2014-035026

(51) Int. Cl. G06T 3/60; G09G 5/37; G09G 5/02; G09G 5/36

(52) U.S. Cl. CPC G06T 3/602; G09G 5/363; G09G 5/37; G09G 5/02; G06T 2210/22; G06T 2210/41; G09G 2380/08; G09G 2340/0492

(57) ABSTRACT

A display system includes a head-mounted display, a mirror image generation unit adapted to generate a mirror image from at least a part of an area of a picture represented by an input video signal, and a control unit adapted to make the head-mounted display display the mirror image generated by the mirror image generation unit.

### BACKGROUND

1. Technical Field

The present invention relates to a display system, a health apparatus, and a display control method.

2. Related Art

It has been studied to make use of an electronic display system for a rehabilitation support of a patient with difficulty in moving extremities. For example, JP-A-2004-298430 (Document 1) discloses a pain treatment support device used for rehabilitation of a patient with phantom limb pain.

The technology described in Document 1 is limited in application to the rehabilitation of a patient with phantom limb pain.

### SUMMARY

An advantage of some aspects of the invention is to provide a display system applicable to a wider variety of applications.

An aspect of the invention provides a display system including a head-mounted display, a mirror image generation unit adapted to generate a mirror image from at least a part of an area of a picture represented by an input video signal, and a control unit adapted to make the head-mounted display display the mirror image generated by the mirror image generation unit.

According to this display system, the display system can be used for an application using the mirror image.

The head-mounted display may include a transmissive display section.

According to this display system, the display system can be used for an application displaying the mirror image and the background together with each other.

The control unit may make the head-mounted display display a picture obtained by deleting the part of the area of the picture represented by the input video signal.

According to this display system, the mirror image with more sense of reality can be provided.

The input video signal may represent a real-time picture shot by a camera.

According to this display system, the mirror image with more sense of reality can be provided.

The picture represented by the input video signal may include a picture of a region of a human body.

According to this display system, the mirror image of the picture of a region of a human body can be obtained.

The control unit may eliminate a part other than a human body out of the picture represented by the input video signal.

According to this display system, the mirror image of a region of a human body can be used.

The input video signal may be a signal compliant with an RGB color system, the display system may further include a conversion unit adapted to convert a signal in the RGB color system into a signal in an HSV color system, and an extraction unit adapted to extract a part of a human body from a picture represented by the signal obtained by the conversion performed by the conversion unit, and the control unit may eliminate a part other than the part extracted by the extraction unit.

According to this display system, the mirror image of a region of a human body can be used.

The head-mounted display may display a stereoscopic picture.

According to this display system, the mirror image with more sense of reality can be provided.

Another aspect of the invention provides a health apparatus including a head-mounted display, a mirror image generation unit adapted to generate a mirror image from at least a part of an area of a picture represented by an input video signal, and a control unit adapted to make the head-mounted display display the mirror image generated by the mirror image generation unit.

According to this health apparatus, the rehabilitation using the mirror image can be performed.

Still another aspect of the invention provides a display control method including generating a mirror image from at least a part of an area of a picture represented by an input video signal, and making a head-mounted display display the mirror image generated in the generating of a mirror image.

According to this display control method, the display control method can be used for an application using the mirror image.

### BRIEF DESCRIPTION OF THE DRAWINGS

The invention will be described with reference to the accompanying drawings, wherein like numbers reference like elements.

FIG. 1 is a diagram showing a general configuration of a display system 1 according to an embodiment of the invention.

FIG. 2 is a diagram showing a general configuration of an HMD 10.

FIG. 3 is a diagram showing a functional configuration of the display system 1.

FIG. 4 is a diagram showing a hardware configuration of a control device 30.

FIG. 5 is a flowchart showing an operation of the display system 1 according to the embodiment.

FIG. 6 is a diagram showing an example of a picture shot by a camera 20.

FIG. 7 is a diagram showing an example of a state in the step S104.

FIG. 8 is a diagram showing an example of a state in the step S105.

FIG. 9 is a diagram showing an example of a state in the step S106.

FIG. 10 is a diagram showing an example of an image visually recognized by the user.

FIG. 11 is a diagram showing an arrangement of the camera 20 according to Modified Example 7.

### DESCRIPTION OF EXEMPLARY EMBODIMENT

### 1. CONFIGURATION

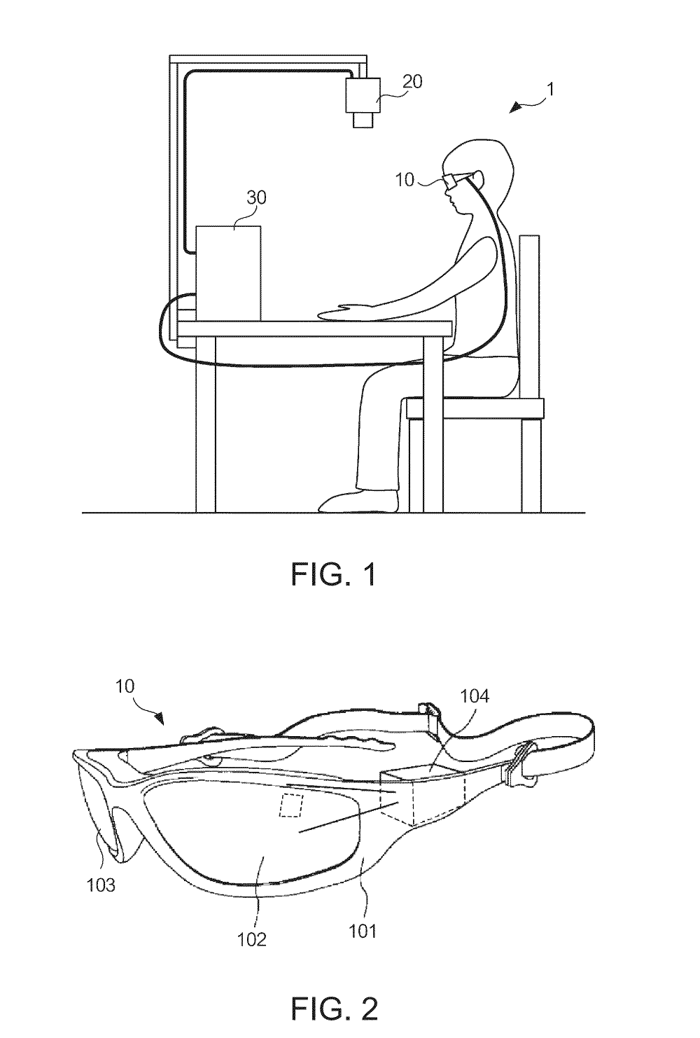

FIG. 1 is a diagram showing a general configuration of a display system 1 according to an embodiment of the invention. In this example, the display system 1 is a health apparatus used for rehabilitation support of a patient with quadriplegia. Specifically, the display system 1 provides a rehabilitation method of shooting an image of the right arm of a patient who has paralysis in left arm but can normally move the right arm, for example, then showing a mirror image (which seems like the left arm) of the shot image to the patient to thereby provide an illusion that the left arm is moving, and thus achieving the functional recovery of the left arm. This method is called mirror therapy.

The display system 1 includes a head-mounted display (HMD) 10, a camera 20, and a control device 30.

FIG. 2 is a diagram showing a general configuration of the HMD 10. The HMD 10 is a display device used in a state of being mounted to the head of the user. The HMD 10 includes a mount section 101, a display section 102, a display section 103, and a display device 104. The mount section 101 is a member to be mounted to the head of the user, such as a glassframe or a headband. The display section 102 and the display section 103 each display an image. The relative positional relationship between the mount section 101, the display section 102, and the display section 103 is designed so that the display section 102 is disposed at the position corresponding to the right eye of the user, and the display section 103 is disposed at the position corresponding to the left eye of the user in the state in which the mount section 101 is mounted correctly. The display device 104 displays pictures on the display section 102 and the display section 103. The display device 104 includes, for example, an input section, a signal processing section, a light source, a light modulation section, and a projection section (all not shown). The input section receives an input of a video signal from the outside. The signal processing section performs a predetermined process on the video signal. The light source outputs light. The light modulation section modulates the light from the light source in accordance with the video signal. The light modulation section includes, for example, a liquid crystal panel. The projection section projects the light modulated by the light modulation section to the display section 102 and the display section 103. The projection section includes an optical system such as a lens, a prism, or a mirror. In this embodiment, the HMD 10 is a so-called see-through HMD. Specifically, the display section 102 and the display section 103 are each a transmissive display section for reflecting the picture projected by the display device 104 and at the same time transmitting the background.

The camera 20 outputs the video signal representing the shot picture (a moving image or a still image). The control device 30 controls the picture to be displayed by the HMD 10 in accordance with the video signal output from the camera 20.

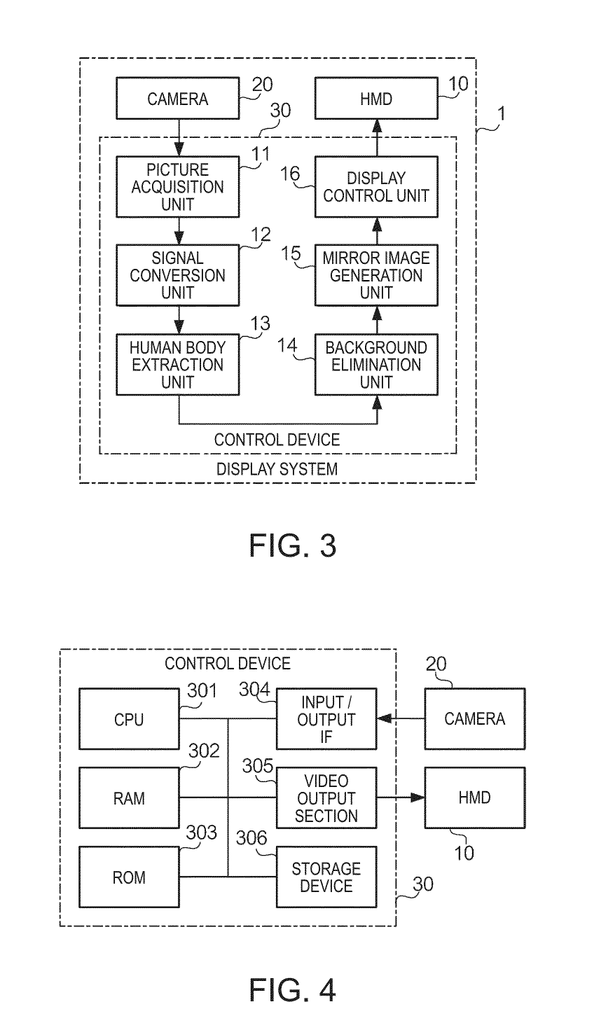

FIG. 3 is a diagram showing a functional configuration of the display system 1. The display system 1 includes a picture acquisition unit 11, a signal conversion unit 12, a human body extraction unit 13, a background elimination unit 14, a mirror image generation unit 15, and a display control unit 16. The picture acquisition unit 11 obtains the video signal from a video source. In this embodiment, the video signal represents a real-time picture shot by the camera 20. The video signal represents a color picture using a predetermined color system (e.g., RGB system). The signal conversion unit 12 converts the color system of the picture represented by the video signal into another color system (e.g., HSV system). The human body extraction unit 13 identifies (i.e., extracts) the region representing a human body out of the picture using the video signal thus converted. The background elimination unit 14 eliminates the background part (i.e., a part other than the human body) out of the picture. The mirror image generation unit 15 generates the mirror image with respect to the picture with the background eliminated. The display control unit 16 controls the HMD 10 so as to display the mirror image thus generated.

FIG. 4 is a diagram showing a hardware configuration of the control device 30. The control device 30 is a computer device including a central processing unit (CPU) 301, a random access memory (RAM) 302, a read only memory (ROM) 303, and input/output interface 304, a video output section 305, and a storage device 306. The CPU 301 is a processing device for performing a variety of processes in accordance with a program. The RAM 302 is a storage device functioning as a working area when the CPU 301 executes the program. The ROM 303 is a nonvolatile storage device storing a program and data used for start-up of the control device 30. The input/output interface 304 is an interface for receiving the video signal output from the camera 20, and relays the signal in accordance with a predetermined standard (e.g., USB (Universal Serial Bus)). The video output section 305 outputs the video signal to the HMD 10. The HMD 10 and the control device 30 can be connected to each other with wire, or can wirelessly be connected to each other. The storage device 306 is anon-volatile storage device (a so-called storage) for storing programs and data, and includes, for example, a hard disk drive (HDD) or a flash memory.

In this example, the storage device 306 stores a program (hereinafter referred to as a “support program”) for making the display system 1 function as a rehabilitation support device. By the CPU 301 executing the support program, the function explained with reference to FIG. 2 is implemented in the control device 30. Here, the input/output interface 304 is an example of the picture acquisition unit 11. The CPU 301 executing the support program is an example of the signal conversion unit 12, the human body extraction unit 13, the background elimination unit 14, the mirror generation unit 15, and the display control unit 16.

### 2. OPERATION

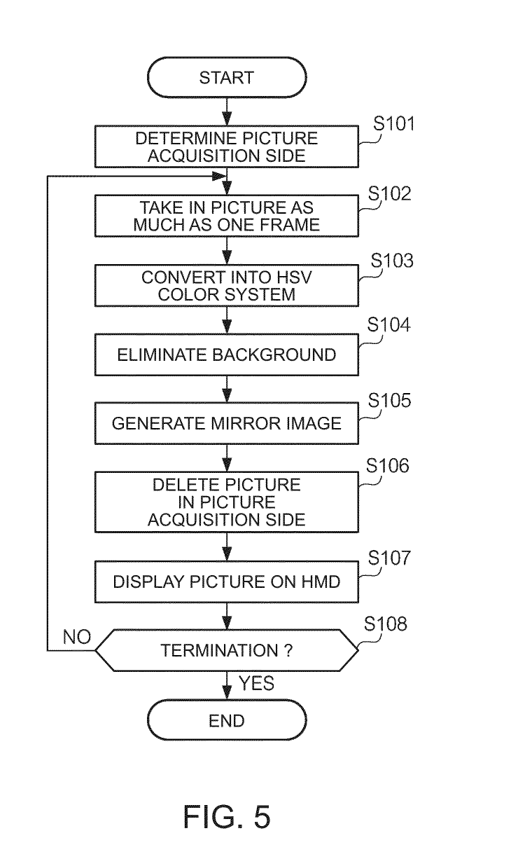

FIG. 5 is a flowchart showing an operation of the display system 1 according to the embodiment. The start of the flow shown in FIG. 5 is triggered by, for example, an instruction of the execution of the support program. In the following explanation, the support program is described as a subject of the process in some cases, which means that the CPU 301 executing the support program performs the process in cooperation with other hardware. It should be noted that at the beginning of the flow shown in FIG. 5, the user (the patient) wears the HMD 10 on the head, and keeps a posture ready for the instruction of the support program.

The use state of the display system 1 is as shown in FIG. 1. In this example, the user is a patient having paralysis in either one of the arms. The user is sitting on a chair, and putting the both arms on a desk. The user is looking at the periphery of the both arms of him- or herself.

FIG. 6 is a diagram showing an example of the picture shot by the camera 20. As shown in the drawing, the camera 20 shoots the picture of the both arms of the user in the entire screen. When dividing the screen in the middle into two parts, the right arm is in the right half screen, and the left arm is in the left half screen.

FIG. 5 is referred to again. In the step S101, the support program determines a picture acquisition side. The picture acquisition side denotes a region forming an origin from which the mirror image is generated. For example, with respect to the user who has paralysis in left arm but can normally move the right arm, the right half of the picture is set to the picture acquisition side. In contrast, with respect to the user who has paralysis in right arm but can normally move the left arm, the left half of the picture is set to the picture acquisition side. The picture acquisition side is input by the user or the caregiver of the user.

In the step S102, the support program takes in the picture represented by the video signal input from the camera 20 as much as one frame. Specifically, the support program stores video data corresponding to the one frame in the RAM 302.

In the step S103, the support program converts the color system of the video data stored in the RAM 302 from the RGB system into the HSV system. The conversion from the RGB system into the HSV system is performed in such a manner as described below, for example. It should be noted that in this example, R, G, and B components are each 8-bit data in the video data. Further, a variable MAX represents a grayscale value representing the maximum grayscale among the R, G, and B components, and a variable MIN represents a grayscale value representing the minimum grayscale among the R, G, and B components. It should be noted that in this example, an H component takes a value of 0 through 360, an S component and a V component each take a value of 0 through 255 in the HSV color system. It should be noted that the support program stores both of the video data in the RGB system and the video data in the HSV system in the RAM 302 with respect to the frame as the processing object.

### Regarding H Component

(1) If MAX=MIN is true:

H=0
(2) If R component is the maximum:

$$H = ( 60 \times \frac{G - B}{MAX - MIN} + 360 ) mod 360$$

(3) If G component is the maximum:

$$H = 60 \times \frac{B - R}{MAX - MIN} + 120$$

(4) If B component is the maximum:

$$H = 60 \times \frac{R - G}{MAX - MIN} + 240$$

### Regarding S Component

(1) If MAX=0 is true:

S=0
(2) If MAX≠0 is true:

$$S = 255 \times \frac{MAX - MIN}{MAX}$$

### Regarding V Component

V=MAX

In the step S104, the support program eliminates the background from the video data in the RGB system. The elimination of the background is performed in, for example, the following manner. The support program corrects the grayscale (color) of the pixel in the video data in the RGB system into black, the pixel corresponding to the pixel (specifically the pixel having the H component fulfilling a certain condition (e.g., H<48 or H>340)) representing other colors than the skin color out of the video data of the picture acquisition side in the HSV system. It should be noted that it is sufficient for the process to be performed only with respect to the picture acquisition side.

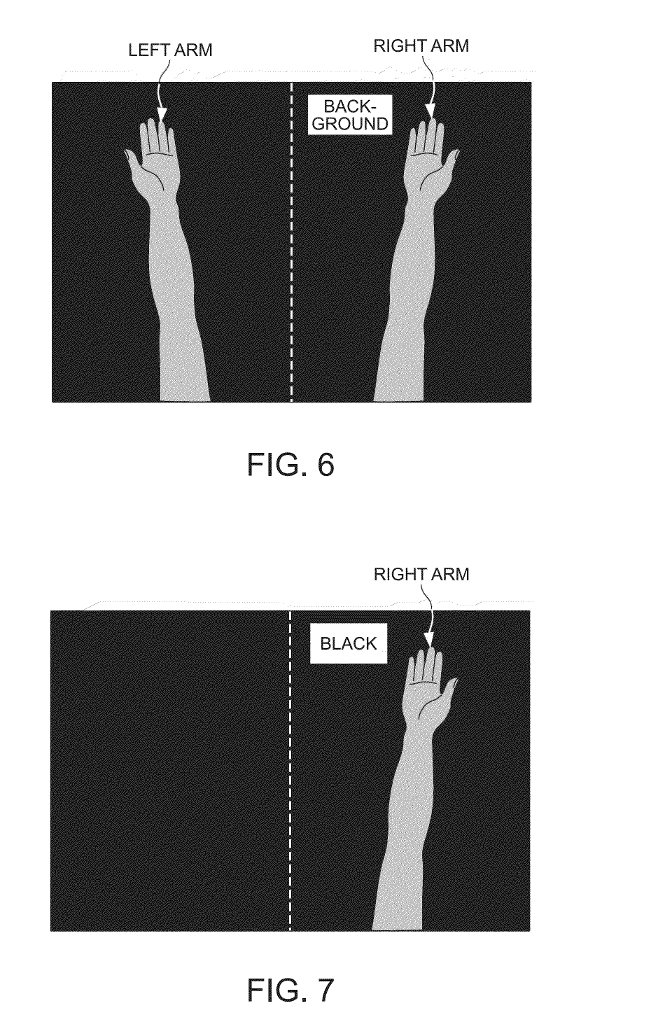

FIG. 7 is a diagram showing an example of a state in the step S104. Here, the part other than the part (arm) with the skin color is eliminated, and is changed to black. Further, the grayscales of the pixels in the area other than the picture acquisition side are all corrected to black.

FIG. 5 is referred to again. In the step S105, the support program generates data (hereinafter referred to as “mirror image data”) representing the mirror image obtained by horizontally flipping the video data in the RGB system with the background eliminated. The support program writes the mirror image data in the storage area corresponding to the area other than the picture acquisition side out of the storage area of the video data in the RGB system of the RAM 302. For example, in the case in which the picture acquisition side is the right side, the support program generates the mirror image from the right half of the picture, and then writes the mirror image thus generated in the left half thereof.

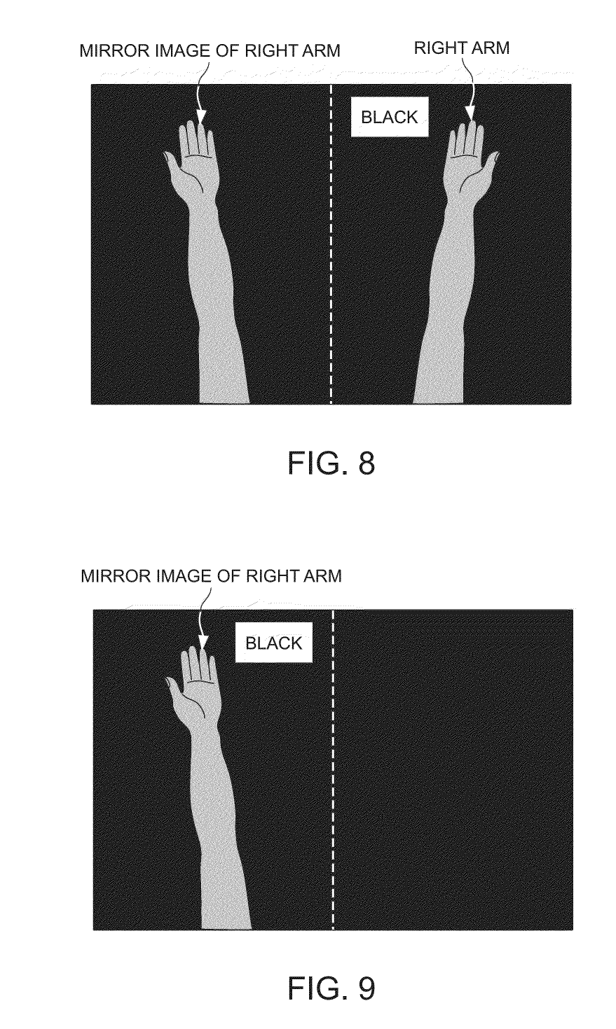

FIG. 8 is a diagram showing an example of a state in the step S105. In the area other than the picture acquisition side, there is written the mirror image of the right arm.

FIG. 5 is referred to again. In the step S106, the support program deletes the picture of the picture acquisition side. Specifically, all of the grayscales (colors) of the pixels in the picture acquisition side are changed to black.

FIG. 9 is a diagram showing an example of a state in the step S106. In the area other than the picture acquisition side, there is written the mirror image of the right arm, and the whole area of the picture acquisition side is corrected to black.

FIG. 5 is referred to again. In the step S107, the support program controls the HMD 10 so as to display the picture represented by the video data in the RGB system on which the process described above has been performed. In other words, the support program outputs the video signal, which has been generated using the video data in the RGB system stored in the RAM 302, to the HMD 10. The HMD 10 displays the picture in accordance with the video signal.

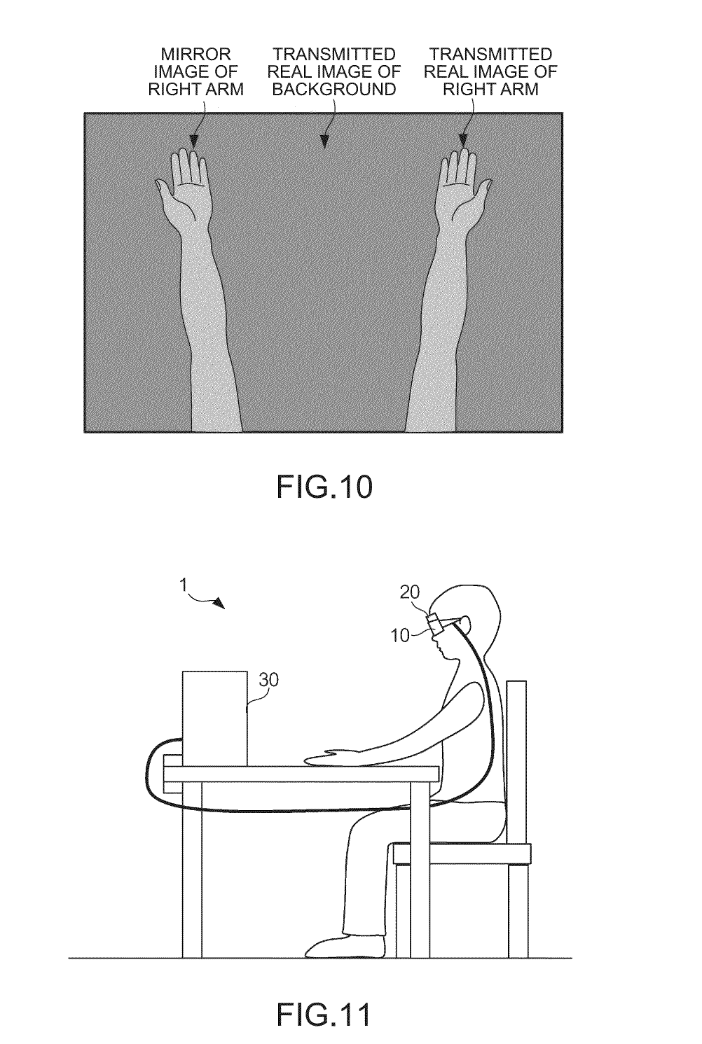

FIG. 10 is a diagram showing an example of an image visually recognized by the user. In the left half of the picture, there is shown the mirror image generated from the picture of the right arm. In the areas of the display section 102 and the display section 103 where the black color is displayed, the background is transmitted. In the right half of the picture, there is shown the real right arm transmitted through the background, namely the display section. When the user moves the right arm, it seems as if the left arm as the mirror image is moving.

FIG. 5 is referred to again. In the step S108, the support program determines whether or not the termination condition has been fulfilled. The termination condition is a condition that, for example, a termination instruction from the user is input. In the case in which the termination condition has not been fulfilled (NO in the step S108), the support program makes a transition of the process to the step S102. In the case in which the termination condition has been fulfilled (YES in the step S108), the support program terminates the flow in FIG. 5.

In the past, the mirror therapy is performed with the both arms put in a box having a mirror installed obliquely. In this method, it results that the patient performs the rehabilitation while looking at the box, which lacks a sense of reality. However, according to the present embodiment, the rehabilitation can be performed in a sight around the patient via the see-through HMD 10, and it is expected that the performance of the rehabilitation is enhanced.

### 3. MODIFIED EXAMPLES

The invention is not limited to the embodiment described above, but can be put into practice with a variety of modifications. Hereinafter, some modified examples will be explained. It is also possible to use two or more of the modified examples described below in combination.

### 3-1. Modified Example 1

The HMD 10 is not limited to the see-through HMD, but can also be a closed HMD, which does not transmit the background. In this case, it is also possible for the support program to combine other pictures (pictures shot by the camera, or a background picture prepared in advance) with the part other than the arm.

### 3-2. Modified Example 2

The picture in the picture acquisition side can also be displayed directly without being deleted. In the case of using the closed HMD, the picture of the both arms is displayed according to this configuration. Although in the case of using the see-through HMD, the arm of the picture and the real arm seen through the display overlap each other, no problem occurs depending on the situation of use.

### 3-3. Modified Example 3

The video source is not limited to the real-time picture from the camera 20. It is also possible that, for example, the picture of moving the right arm of the patient is shot in advance, and the picture is reproduced repeatedly during the rehabilitation as the video source.

### 3-4. Modified Example 4

The process (step S104) of eliminating the background other than the arm can be omitted. In other words, it is also possible to generate the mirror image directly from the picture in the picture acquisition side including the background. This configuration is effective in the case of using the closed HMD.

### 3-5. Modified Example 5

The method of extracting the human body (the skin color) is not limited to the method explained in the embodiment. It is also possible to determine whether or not the pixel has the skin color based on the relationship between the grayscale values of the R, G, and B components while keeping the RGB system without converting the video data into the HSV system.

### 3-6. Modified Example 6

The picture displayed on the HMD 10 can also be a stereoscopic picture. Since in the HMD 10, the picture for the right eye and the picture for the left eye can independently be displayed, the stereoscopic picture can easily be displayed. Thus, the rehabilitation with more sense of reality can be performed.

### 3-7. Modified Example 7

FIG. 11 is a diagram showing an arrangement of the camera 20 according to Modified Example 7. The camera 20 can also be attached to the HMD 10. According to this arrangement, the picture shot by the camera 20 becomes more similar to the view field of the user, and thus, the rehabilitation with more sense of reality can be performed.

### 3-8. Other Modified Examples

The application of the display system 1 is not limited to the rehabilitation. The display system 1 can also be used in applications such as a game other than the rehabilitation.

In the description of the embodiment, there is explained the example in which the control device 30 is the computer device, and the process is performed in accordance with the support program. However, the function explained in the description of the embodiment can also be implemented as hardware using a field-programmable gate array (FPGA) or a dedicated integrated circuit (IC). Further, a part or the whole of the function explained to be provided to the control device 30 in the description of the embodiment can also be provided to the HMD 10.

The entire disclosure of Japanese Patent Application No. 2014-035026, filed Feb. 26, 2014 is expressly incorporated by reference herein.

What is claimed is:

1. A display system comprising:
a head-mounted display;
a mirror image generation unit adapted to generate a mirror image from at least a part of an area of a picture represented by an input video signal; and
a control unit adapted to make the head-mounted display display the mirror image generated by the mirror image generation unit.

2. The display system according to claim 1, wherein
the head-mounted display includes a transmissive display section.

3. The display system according to claim 2, wherein
the control unit makes the head-mounted display display a picture obtained by deleting the part of the area of the picture represented by the input video signal.

4. The display system according to claim 1, wherein
the input video signal represents a real-time picture shot by a camera.

5. The display system according to claim 1, wherein
the picture represented by the input video signal includes a picture of a region of a human body.

6. The display system according to claim 1, wherein
the control unit eliminates a part other than a human body out of the picture represented by the input video signal.

7. The display system according to claim 6, wherein
the input video signal is a signal compliant with an RGB color system,
the display system further comprises:
a conversion unit adapted to convert a signal in the RGB color system into a signal in an HSV color system; and
an extraction unit adapted to extract a part of a human body from a picture represented by the signal obtained by the conversion performed by the conversion unit,
wherein the control unit eliminates a part other than the part extracted by the extraction unit.

8. The display system according to claim 1, wherein
the head-mounted display displays a stereoscopic picture.

9. A health apparatus comprising:
a head-mounted display;
a mirror image generation unit adapted to generate a mirror image from at least a part of an area of a picture represented by an input video signal; and
a control unit adapted to make the head-mounted display display the mirror image generated by the mirror image generation unit.

10. A display control method comprising:
generating a mirror image from at least a part of an area of a picture represented by an input video signal; and
making a head-mounted display display the mirror image generated in the generating of a mirror image.
